(19) United States
(12) Patent Application Publication
(10) Pub. No.: US 2013/0332235 A1
(43) Pub. Date: Dec. 12, 2013

(54) Optimizing Market Research Based on Mobile Respondent Location

(71) Applicant: Palanivel Kuppusamy, (US)

(72) Inventor: Palanivel Kuppusamy, (US)

(73) Assignee: iPinion, Inc.

(21) Appl. No.: 13/492,158

(22) Filed: Jun. 8, 2012

(51) Int. Cl. G06Q 30/02; H04W 4/02

(52) U.S. Cl. 705/7.34

(57) ABSTRACT

Systems and method for conducting meaningful market research on respondents using mobile devices. Data relating to mobile respondent location is leveraged to initiate more effective market research applications such as surveys. Using a mobile respondent's location, a market research enterprise initiates market research specifically related to that location. The market research applications may be transmitted to a mobile respondent using a number of different mechanisms such as push message, text message, email, etc. Also, mobile respondents may download and install an application that allows them to quickly access the market research applications and transmit the market research data.

### CROSS-REFERENCE TO RELATED APPLICATIONS

This patent application is related to commonly assigned, co-pending U.S. patent application Ser. No. ______, filed Jun. 8, 2012 and entitled “OPTIMIZING MARKET RESEARCH BASED ON MOBILE RESPONDENT BEHAVIOR” (Attorney Docket: ERWP.P0011US), commonly assigned, co-pending U.S. patent application Ser. No. ______, filed Jun. 8, 2012 and entitled “OPTIMIZING MOBILE USER DATA STORAGE” (Attorney Docket: ERWP.P0012US), and commonly assigned, co-pending U.S. patent application Ser. No. ______, filed Jun. 8, 2012 and entitled “OPTIMIZING MARKET RESEARCH USING INDICIA-BASED MOBILE RESPONDENT DATA” (Attorney Docket: ERWP.P0013US) the disclosures of which are incorporated herein by reference in their entirety.

### TECHNICAL FIELD

This disclosure is generally directed to a system and method for optimizing mobile respondent market research. This disclosure is specifically directed to systems and methods for optimizing market research by considering mobile respondent location.

### BACKGROUND

Market research is an organized effort to gather information about markets or customers. Market research can include social and opinion research performed to systematically gather and interpret information about individuals or organizations using statistical and analytical methods and techniques of the applied social sciences to gain insight or support decision making. Viewed as an important component of business strategy, market research can be a key factor to obtain advantage over competitors. Market research provides important information to identify and analyze market need, market size, and competition. The advent of mobile devices, such as smart phones, presents new opportunities for enlisting mobile device users as mobile respondents in performing market research.

### SUMMARY

According to an embodiment, methods and systems are provided for conducting mobile respondent market research. A location of interest is first identified. Also, a determination is then made whether a mobile respondent comes within a proximity of the location of interest. If so, a market research application is transmitted to the mobile respondent.

According to another embodiment, other methods and systems are provided for conducting mobile respondent market research. A mobile device receives a market research application that has been selected, at least in part, in response to a determination of the mobile device's proximity to a location of interest. In response, the mobile device transmits market research data based upon the market research application.

According to one embodiment, other methods and systems are provided for conducting mobile respondent market research. One or more locations are identified for conducting market research. Also, instructions to initiate a market research application if a mobile respondent comes within a proximity of one or more locations are provided. Further, market research data relating to the market research application is received.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE FIGURES

For a more complete understanding of the present disclosure, reference is now made to the following descriptions taken in conjunction with the accompanying figures, in which:

FIG. 1 illustrates a network in which concepts described herein may be implemented;

FIG. 2 illustrates functional blocks executed to perform a method of mobile respondent market research according to the concepts described herein;

FIG. 3 illustrates functional blocks of components of an apparatus for mobile respondent market research according to the concepts described herein;

FIG. 4 illustrates system components for performing another method of mobile respondent market research according to the concepts described herein;

FIG. 5 illustrates functional blocks of components of another apparatus for mobile respondent market research according to the concepts described herein;

FIG. 6 illustrates functional blocks executed to perform another method of mobile respondent market research according to the concepts described herein; and

FIG. 7 illustrates functional blocks of components of another apparatus for mobile respondent market research according to the concepts described herein.

### DETAILED DESCRIPTION

Systems and methods described herein provide a mechanism for conducting meaningful market research on respondents using mobile devices. Data relating to mobile respondent location is leveraged to initiate more effective market research applications such as surveys and the like. Using a mobile respondent's location, a market research enterprise interested in focused market research may initiate market research specifically related to that location. For example, a respondent determined to be in a Wal-Mart may be questioned about her shopping experience; while a respondent determined to be at a car dealership may be questioned about her experience with sales personnel. The market research applications may be transmitted to mobile respondents by a number of different mechanisms such as push message, text message, email, etc. Also, mobile respondents may download and install an application that allows them to quickly access the market research applications and transmit the market research data.

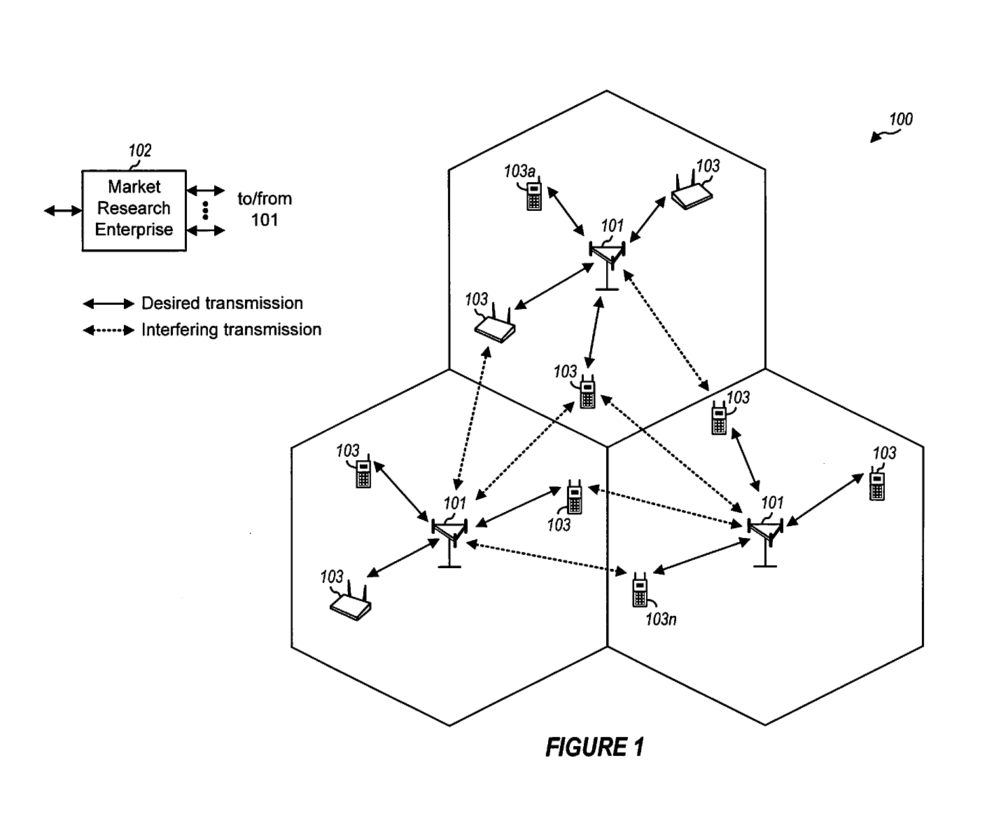

FIG. 1 illustrates network 100 in which concepts described herein may be implemented. Middleware system 101 is in communication with market research enterprise 102 and a plurality of mobile devices 103a-103n. Middleware system 101 is shown as a distributed network, having a plurality of base stations/eNodeBs that coordinate with one another to perform operations described herein. However, it will be understood by those of skill in the art that all or portions of middleware system 101 will comprise a centralized location (perhaps one of a base station/eNodeB, a controller, or enterprise) to enable the operations. As will be further described, middleware system 101 communicates with market research enterprise 102 and mobile devices 103 to enable market research for mobile respondents who come within a proximity of one or more locations of interest. According to one embodiment, middleware 101 and/or market research enterprise 102 may be a market research enterprise that focuses on conducting market research on respondents.

Network 100 may be implemented using a number of wireless communication methods between middleware system 101 and mobile devices 103 and wireless and/or wireline communication methods between middleware system 101 and market research enterprise 102. Such wireless methods include CDMA, TDMA, FDMA, OFDMA, SC-FDMA. A CDMA network may implement a radio technology, such as Universal Terrestrial Radio Access (UTRA), Telecommunications Industry Association's (TIA's) CDMA2000®, and the like. The UTRA technology includes Wideband CDMA (WCDMA) and other variants of CDMA. The CDMA2000® technology includes the IS-2000, IS-95 and IS-856 standards from the Electronics Industry Alliance (EIA) and TIA. A TDMA network may implement a radio technology, such as Global System for Mobile Communications (GSM). An OFDMA network may implement a radio technology, such as Evolved UTRA (E-UTRA), Ultra Mobile Broadband (UMB), IEEE 802.11 (Wi-Fi), IEEE 802.16 (WiMAX), IEEE 802.20, Flash-OFDMA, and the like. The UTRA and E-UTRA technologies are part of Universal Mobile Telecommunication System (UMTS). 3GPP Long Term Evolution (LTE) and LTE-Advanced (LTE-A) are newer releases of the UMTS that use E-UTRA. UTRA, E-UTRA, UMTS, LTE, LTE-A and GSM are described in documents from an organization called the “3rd Generation Partnership Project” (3GPP). CDMA2000® and UMB are described in documents from an organization called the “3rd Generation Partnership Project 2” (3GPP2). The techniques described herein may be used for the wireless networks and radio access technologies described above, as well as other wireless networks and radio access technologies. According to a preferred embodiment, middleware system 101 communicates with market research enterprise 102 and/or mobile devices 103 using LTE or LTE-A wireless communication methods.

While middleware system 101 is illustrated as separate from market research enterprise 102, it should be appreciated that, in some embodiments, middleware system 101 and market research enterprise 102 may be collocated and operate under the direction of shared hardware and software.

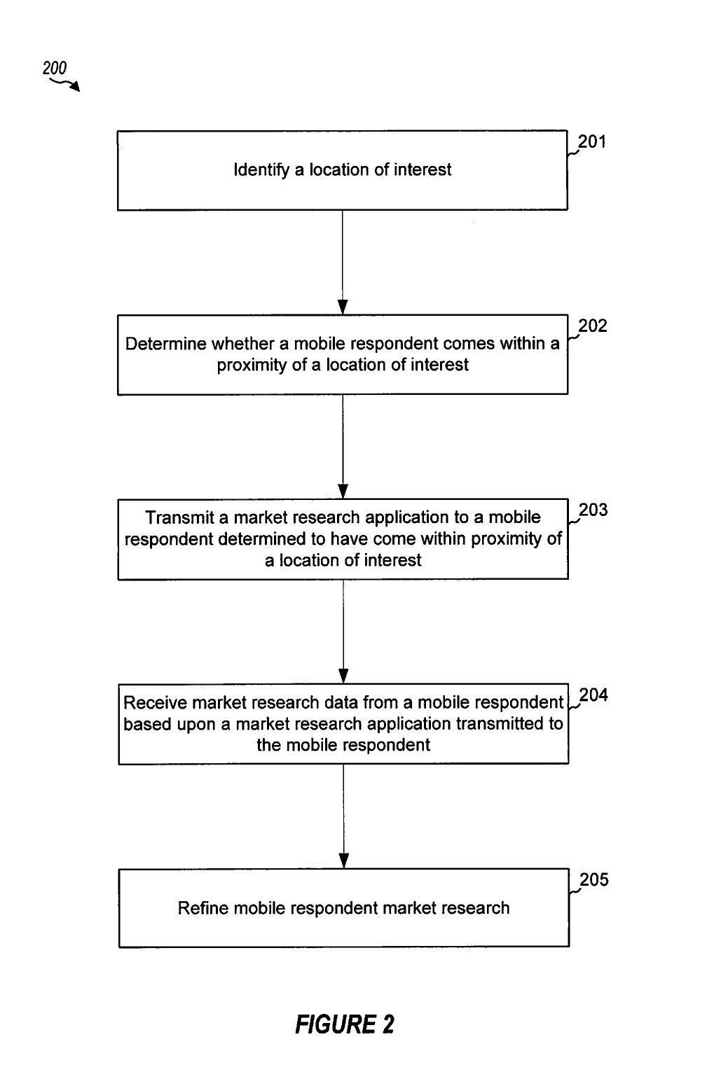

FIG. 2 illustrates functional blocks executed to perform a method of mobile respondent market research according to the concepts described herein. Specifically, FIG. 2 illustrates functional blocks executed by a middleware system such as middleware system 101 illustrated at FIG. 1.

At block 201a location of interest is identified. Identifying a location of interest may be accomplished by receiving the identity from an external source such as market research enterprise 102 or generating a location of interest at middleware system 101. In either case, a location of interest may be thought of as one or more locations that triggers a market research application. Where a location of interest is received from a source such as market research enterprise 102, that location of interest may be first generated by market research enterprise 102 as a means to conduct market research for businesses at the location of interest and/or certain segments of respondents within the market. Market research enterprise 102 may wish to conduct market research for all respondents determined to have shopped at a particular business, likely to have purchased a particular product, attended a particular movie, test-driven a particular vehicle, and the like. In such cases, market research enterprise 102 may provide to middleware system 101 locations of interest as particular stores, movie theaters, or car dealerships by name or merely in terms of raw data sufficient to describe their geographic location.

Where a location of interest is generated at middleware system 101, that location of interest may be generated according to requests or criteria provided by market research enterprise 102 and respondent profile data at middleware system 101. For example, market research enterprise 102 may express a desire to conduct market research on males between the ages of 18-35 who have had a particular type of shopping experience (for example, those determined to have shopped for home improvement products). In that case, middleware system 101 may generate a set of locations of interest to include Home Depot, Lowes, and Target, and later refine its analysis to those respondents who are male and within the specified age range. In that case, market research enterprise 102 does not provide specific names or coordinates to middleware system 101; rather, it is left to middleware system 101 to generate locations of interest to satisfy market research enterprise 102's needs.

The location of interest may be defined differently depending on system parameters, client preferences, and the like. According to one example, the location of interest may be defined in terms of “raw” data where the location of interest is defined in terms of coordinates, GPS references, latitude and longitude, and the like. Also, information such as street address, resolved latitude-longitude data, and/or data provided by a third party may be used to define the location of interest. According to another example, the location of interest may defined in terms of characteristics of that location. That is, a location of interest may be defined by a particular business or enterprise at the location. The locations of interest may be stored in terms of one or multiple instances, enabling middleware system 101 to determine when a mobile respondent comes in proximity of, for example, a Wal-Mart, or a number of different coordinates without regard to what, if any, business may be located thereat.

At block 202 a determination is made whether a mobile respondent comes within a proximity of a location of interest. The determination may be made in different temporal respects. The determination may be made by looking back in time where, for example, one or more sets of mobile respondent location data is examined over a preceding time interval. By way of example, middleware system 101 may review and analyze the location history of mobile respondents for the previous two weeks and determine which mobile respondents were in proximity to a location of interest during that time interval. Also, the determination may be made during or close to real-time, so that middleware system 101 is able to identify which mobile respondents are currently at or near a location of interest. Further, the determination may be predictive where, for example, middleware 101 predicts whether a mobile respondent will move in proximity to a location of interest at a future time. In that case, such a forward-looking determination or prediction may be based on additional data including past behavioral data such as the number of times the mobile respondent previously came in proximity to the location of interest, a likelihood of doing so based on respondent profile data (for example, does the respondent fit a profile of someone who would shop at a business at the location of interest), currently-observed behavior (for example, is the respondent apparently taking a direct path to the location of interest or meandering without a clear direction), and the like.

The determination made at block 202 requires at least some understanding of mobile respondent location, whether it be past, current, or predicted location. As such, middleware system 101 implements mechanisms for collecting and storing mobile respondent location data. According to one embodiment, middleware system 101 may monitor the location of each mobile device 103 (used by a mobile respondent) via a mechanism similar to that utilized by common cellular networks, where a location of each mobile device 103 is resolved by triangulation techniques and the like by base stations serving the cell in which mobile device 103 currently resides. According to an additional embodiment, middleware system 101 may utilize specific location-based communications transmitted from mobile devices 103. Where mobile devices 103 implement GPS-type functionality, each mobile device 103 may transmit GPS data to middleware system 101 which uses that data to launch a market research application as described herein. It should be appreciated that determining a location of a mobile device 103 using either a network-based method (for example, base station/eNodeB triangulation, network statistics data, etc.) or specific location data transmitted from mobile device 103 is a trade off. Relying upon specific location data transmitted from mobile devices 103 may provide more accurate and more up-to-date data; however, it also requires more power from mobile devices 103, more storage space at middleware system 101, and is computationally intensive.

It should be appreciated that storing location data for mobile devices 103 and their corresponding respondents may be unduly burdensome on middleware system 101. Even where the location data of mobile devices 103 is basic, the cumulative volume of stored data per time interval per mobile device 103 may be relatively large. This causes difficulties both in terms of physical and computational resources. Therefore, according to one embodiment a mechanism for reducing storage requirements of data relating to mobile respondent may be implemented at middleware system 101. Such a mechanism is described in a related, commonly assigned, co-pending U.S. patent application Ser. No. ______, filed Jun. 8, 2012 and entitled “OPTIMIZING MOBILE USER DATA STORAGE,” the disclosure of which is incorporated herein in its entirety. According to one embodiment, middleware system 101 may collect location data for each mobile respondent at predetermined time intervals and store the location of the mobile respondent for subsequent comparison to locations of interest. Of course, the frequency at which location data is collected will affect the accuracy at which it can be determined whether a mobile respondent came within proximity of a location of interest. This must be balanced against the additional storage and computational requirements associated with collecting location data at a higher frequency. As described in the previously described cross-referenced patent application, the frequency at which mobile respondent location data is collected for storage may vary according to different mechanisms, depending on client requirements, a given market research application, system limitations, and the like. Some market research applications such as a surveys based on movies may require a lower collection frequency as the event of interest occurs over a relatively long period of time, whereas applications such as surveys based on a fast food restaurant may require higher frequency collection as the event of interest typically lasts only a few minutes. Further, the frequency at which mobile respondent location data is collected may vary according to day of week, time of day, etc., where expected periods of inactivity require very little data collection.

It should be appreciated that, in real-time applications, the frequency at which location data is collected for a mobile respondent may vary according to the mobile respondent's actual location. Where a mobile respondent is determined to be within a proximity of a location of interest, the interest in respondent behavior and/or available market research is heightened. The frequency at which location data is collected may increase to track more precise respondent movement at or near a location of interest. Where, for example, a respondent is determined to be in Wal-Mart (location of interest), an increase in collection of location data may enable a determination of the specific section or aisle within the Wal-Mart at which the mobile respondent is located. With this data, subsequent or refined market research applications may be transmitted to the mobile respondent, i.e., where a survey relating to a product, display, or layout on a specific aisle is transmitted to the mobile respondent as opposed to a more general survey relating to the respondent's shopping experience at the store.

With the above in mind, a preferred embodiment implements one or a combination of techniques to determine the location of a mobile respondent utilizing a mobile device 103 with respect to a location of interest. One such technique involves receiving locations of interest or generating locations of interest at middleware system 101. Once the locations of interest are determined, a virtual radius or fence may be drawn around the locations of interest. Using software executing at both mobile devices 103 and middleware system 101, a determination may be made as to which mobile respondents come within the radius or fence around the locations of interest. For example, at middleware system 101, location data from mobile devices 103 may be compared to the location defined by the radius or fences. Those mobile devices determined to have crossed the radius or fence are determined to be in proximity of the location of interest. As a result, a market research application may be transmitted to the mobile respondent based on that location according to concepts described herein. According to a preferred embodiment, a mobile respondent determined to have crossed a radius or fence is sent a market research application in or near real-time, such as a push notification leading the mobile respondent to the market research application.

Another technique exploits mobile respondent location in combination features specific to different locations to initiate a mobile market research application. According to such a technique, various businesses or enterprises perhaps differing in industry, service, products may be spread across several locations. Middleware system 101 may track or import locations of each business and various market research applications associated with the businesses. In that case, when a mobile respondent comes within a proximity of any number of different types of business, the mobile respondent is alerted as to different market research application offered for each business. The mobile respondent may be alerted that, by participating in different surveys and the like for the various businesses, he/she will be eligible for various offers.

Yet another technique involves storing a history of mobile respondent locations and subsequently comparing those locations to locations of interest. This technique is advantageous because it is less computationally-intensive and does not require real-time monitoring of mobile respondents. Further, this technique still provides meaningful market research because it allows market research enterprise to reach respondents who have had particular experiences in the near past.

At block 203 a market research application is transmitted to a mobile respondent in response to a determination that the mobile respondent came within proximity of a location of interest. As previously discussed, the market research application may be transmitted at or near real-time with a determination the mobile respondent is within a proximity of a location of interest, may be transmitted after the mobile respondent has been within a proximity of a location of interest, or transmitted based upon a determination or prediction the mobile respondent will soon be in proximity to a location of interest. Further, the determination of what proximity causes transmission of the market research application may be determined by either of market research enterprise 102 or middleware system 101, and may vary according to different mechanisms, depending on client requirements, a given market research application, system limitations, and the like. For example, some market research applications may be initiated where a mobile respondent has come within a mile of a location of interest, while other applications may be initiated where the mobile respondent has come within 20 feet of a location of interest. Further, the proximity of interest may be provided to middleware system 101 by market research enterprise 102, or generated by middleware system 101 upon a formulation of what proximity of interests are thought to satisfy the objectives of market research enterprise 102.

Further, where market research enterprise 102 desires to target specific respondents who travel within a proximity of a location of interest, middleware system 101 may overlay profile data to further restrict which respondents receive a market research application. For example, where a market research enterprise 102 is interested in initiating a market research application only for males between the ages of 18-35 who shop at Wal-Mart, middleware system 101 may narrow all results of mobile respondents coming within the proximity of interest of one or more Wal-Mart's by discarding all respondents who are female and outside of the specified age range. In this way, middleware system 101 uses mobile respondent profile data stored thereat to further refine initiation of a market research application even where a proximity criteria has been otherwise satisfied. Market research applications may comprise surveys with different objectives and may be transmitted according to different format such as push messages, text messages, SRS messages, emails, and the like to a mobile respondent's mobile device 103.

At block 204 market research data is received from a mobile respondent based upon a market research application transmitted to the mobile respondent. The received data may comprise a completed survey, a partially-completed survey, a decline to participate in the survey, a request for additional data or instructions, an error message signifying an unsuccessful survey process (perhaps due to low signal strength of mobile device 103), etc. The received data may be utilized by middleware system 101 in a number of ways and for a number of purposes. Where a declined survey request, an incomplete survey, or an error message is received, middleware system 101 may flag the mobile respondent for follow-up, initiating a subsequent market research application according to a determine time interval. Further the received data may be correlated with other data to interpret the data where, for example, complete survey data is correlated with stored mobile respondent profile data to understand how respondents of different profiles responded to the survey. In that case the correlated data may be transmitted to market research enterprise 102. Otherwise, raw response data may be compiled and transmitted to market research enterprise 102, where market research enterprise 102 correlates or otherwise filters or interprets the market research data received from the mobile respondents. Of course, where middleware system 101 and market research enterprise 102 are collocated, these functions may executed on shared hardware and/or software.

At block 205, according to an additional or alternative embodiment, mobile respondent market research may be refined. Refining the market research may be accomplished by utilizing data collected during or in response to a first market research application and/or the previously described respondent profile data to transmit a second market research application to the respondent. As previously described, the frequency at which location data is collected may increase in response to a determination the respondent is in proximity to a location of interest. According to the previously discussed example, a first market research application may be transmitted to the mobile respondent upon a determination the respondent has entered a Wal-Mart (for example, a survey based on the respondent's shopping experience). However, a second, refined market research application may be transmitted to the mobile respondent upon a determination the respondent is at a particular location within the Wal-Mart (for example, a survey relating to a product, display, or layout on a specific aisle). Mobile respondent market research may be further refined according to the length of time a respondent is determined to be at a particular location of interest and/or response data previously received from the mobile respondent in response to a more general market research application. Also, consistent with the previous discussion, a refined market research application may be transmitted to a respondent based upon that respondent's profile data and/or behavioral data. In the preceding example, the refined survey relating to a specific product, display, or layout of a specific aisle may be transmitted only if the respondent is determined to be a male, between the ages of 18-35, who has visited Wal-Mart at least twice during the preceding month.

Middleware system 101 also stores respondent data that may be used to improve mobile respondent market research. When creating and expanding a respondent database (e.g., as new respondents subscribe to services provided by middleware system 101 or market research enterprise 102 increases), initial data is collected from each respondent. The initial data may comprise data used to create an initial profile such as demographic data, employment and lifestyle data, preference data, respondent preferences, hobbies, general interests, etc. The data may be updated from time to time upon a request for updates transmitted to the respondent, or proactively by the respondent. Further, as time goes on, behavioral data such as internet history, applications downloaded and utilized the most, text message use vs. phone use, etc., may be collected to further refine a respondent's profile or establish a separate behavior index of the respondent. In either event the profile and behavioral data may be used to refine a market research application according to the concepts described herein. A mechanism for passively and actively collecting mobile respondent behavioral data to initiate market research applications is described in a related, commonly assigned, co-pending U.S. patent application Ser. No. ______, filed Jun. 8, 2012 and entitled “OPTIMIZING MARKET RESEARCH BASED ON MOBILE RESPONDENT BEHAVIOR,” the disclosure of which is incorporated herein in its entirety. This data may be compiled to generate respondent profiles that are relied upon to generate locations of interest and/or target specific respondents for market research applications.

It should be appreciated that the functions performed with reference to FIG. 2 may be iterative where, e.g., an updated or revised market research application is transmitted to a mobile device based on updated information received from the mobile device. The updated information may comprise new behavioral data, new market research data, and new location data. Through this iterative process, a market research enterprise can incrementally refine its market research applications to provide more relevant applicators to respondents.

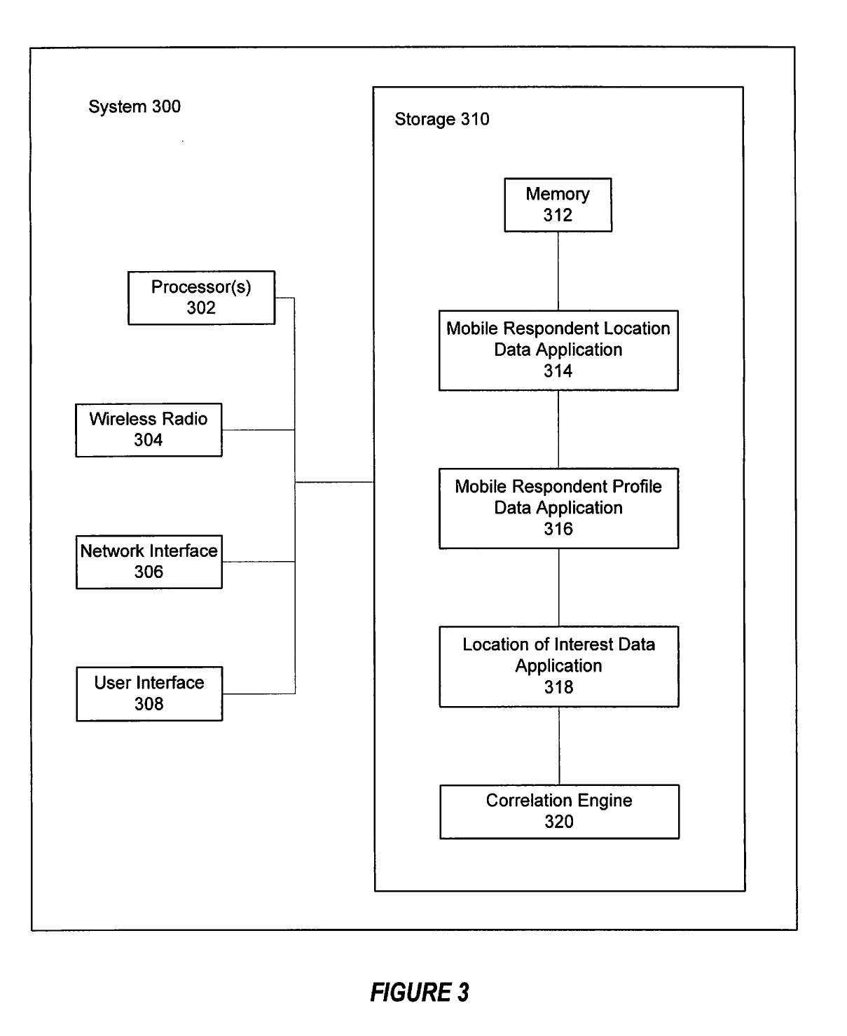

FIG. 3 illustrates a block diagram of components of an apparatus that enables mobile respondent market research according to the concepts described herein. Specifically, FIG. 3 illustrates components of a middleware system such as middleware system 101 illustrated at FIG. 1. Each component may comprise hardware, software, firmware, program code, or other logic (for example, ASIC, FPGA, etc.), as may be operable to provide the functions described herein.

The functionality and operations of middleware system 300 are controlled and executed through processor(s) 302. Processor(s) 302 may include one or more core processors, central processing units (CPUs), graphical processing units (GPUs), math co-processors, and the like. Processor(s) 302 execute program logic, whether implemented through software stored in a memory 312 or in firmware in which logic is integrated directly into integrated circuit components. Middleware system 300 may communicate wirelessly with multiple client systems and mobile devices through various radios, such as wireless radio 304, such as one or more of wireless wide area network (WWAN) radios and wireless local area network (WLAN) radios. If a WWAN radio is included as one of the radios in wireless radio 304, communication would generally be allowed over a long range wireless communication network such as an LTE network. Middleware system 300 may also provide communication and network access through a wired connection with network interface 306. The wired connection may connect to the public-switched telephone network (PSTN), or other communication network, in order to connect to the Internet or other accessible communication network.

Middleware system 300 comprises storage 310, which includes memory 312, mobile respondent location data 314, mobile respondent profile data application 316, location of interest data application 318, and correlation engine 320. Under control of processor(s) 302, program logic stored on memory 312, including mobile respondent location data application 314, mobile respondent profile data application 316, location of interest data application 318, and correlation engine 320, and other applications provides functionality of middleware system 300, including communications, storage, computation, and filtering, analysis, and correlation of location data, profile data, and location of interest data. Such operating applications may be displayed visually to the user via user interface 308. User interface 308 includes various hardware and software applications that control the rendering of visual data onto the display screen of computers of middleware system 300 (not shown). User interface 308, under control of the processor(s) 302, controls and operates all forms of interfaces between the user and middleware system 300. As such, when middleware system 300 is implemented using a touch screen display, user interface 308 may read the user's input and finger motions on the touch screen and translate those movements or gestures into electronic interface navigational commands and data entry. Various embodiments of user interface 308 also will receive the rendered visual data through processing, controlled by processor(s) 302, and display that visual data on the display. During input to a touch screen device, the user interface 308 may be receiving and analyzing input data from a user's finger movements and gestures on the display screen.

Mobile respondent data application 314 may configure the processor(s) 302 to extract stored location data of mobile respondents for various operations described with reference to FIG. 2. Mobile respondent data application 314 may be interfaced with mobile respondent profile data application 316, location of interest data application 318, and correlation engine 320 for use with market research results to correlate and/or filter the data according to specific client requests. Mobile respondent profile data application 316 may configure the processor(s) 302 to extract the profile and/or behavioral data of mobile respondents for various operations described with reference to FIG. 2. Additionally, Mobile respondent profile data application 316 may extract mobile respondent profile data to retrieve demographic data, behavioral data, preferences, etc., for use with market research results to correlate and/or filter the data according to specific client requests. Location of interest data application 318 may configure the processor(s) 302 to extract the locations of interest for various operations described with reference to FIG. 2. Correlation engine 320 may be interfaced with mobile respondent location data application 314, mobile respondent profile data application 316, and location of interest data application 318, or used with market research results to correlate and/or filter the data according to specific client requests. The correlated data may be used to identify or generate specific market research applications to respondents who exhibit certain behaviors, have visited certain locations in the past, and/or come within a proximity of certain locations of interest.

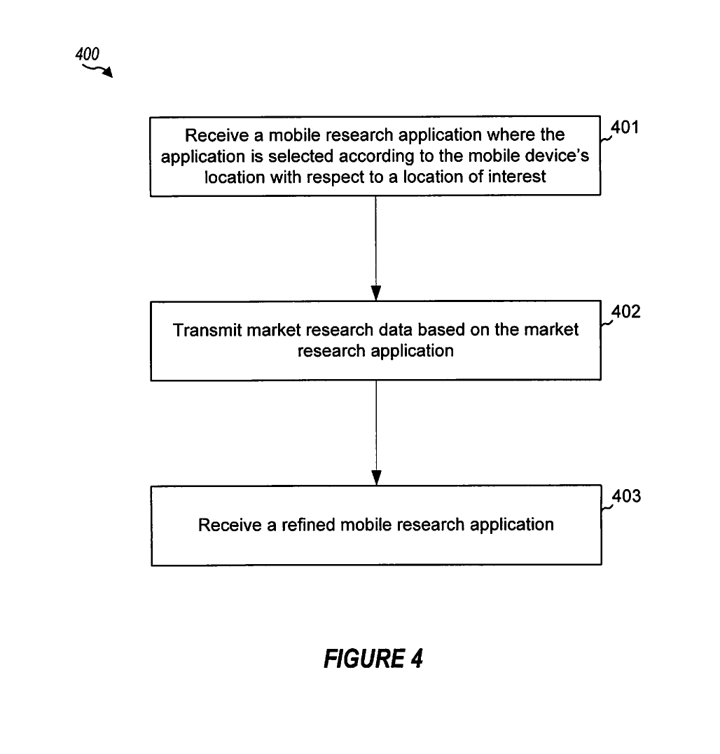

FIG. 4 illustrates functional blocks executed to perform a method of mobile respondent market research according to the concepts described herein. Specifically, FIG. 4 illustrates functional blocks executed by a mobile devices such as one or more of mobile devices 103 illustrated at FIG. 1. The functional blocks may be executed at the direction of one or more of hardware, software, and inputs received from a respondent.

According to an embodiment, a user of mobile device 103 may qualify as a mobile respondent in a number of ways. According to one implementation, a mobile user may sign up to receive market research applications relating to a number of activities experienced by that mobile user. Once done, the mobile respondent may download and install an application on their smart phone or laptop or follow specific links received in, e.g., text messages, emails, and the like, to a survey website to participate in a received market research application. As an initial step, the mobile respondent may further provide data used by other systems to extrapolate behavioral data and/or create a profile for that respondent. Profile data may comprise demographic data, employment and lifestyle data, preference data, respondent preferences, hobbies, general interests, etc. Behavioral data may comprise internet history, applications downloaded and utilized the most, text message use vs. phone use, etc. Where a mobile respondent installs an application such data may be collected passively where, e.g., the application runs in a background to collect respondent behavior. A mechanism for passively and actively collecting mobile respondent behavioral data to initiate market research applications is described in a related, commonly assigned, co-pending U.S. patent application Ser. No. ______, filed Jun. 8, 2012 and entitled “OPTIMIZING MARKET RESEARCH USING INDICIA-BASED MOBILE RESPONDENT DATA,” the disclosure of which is incorporated herein in its entirety.

At block 401 a market research application is received, where the application is selected according to the mobile device's location with respect to a location of interest. The market research application may comprise surveys with different objectives and may be transmitted according to different format such as push messages, text messages, SRS messages, emails, and the like to a mobile respondent's mobile device 103. A location of interest may be defined in terms of “raw” data such as coordinates, GPS references, latitude and longitude, and the like, or may be defined in terms of characteristics of that location. For example, a location of interest may be defined by a particular business or enterprise at the location such as a Wal-Mart.

The mobile device's location with respect to a location of interest may be a determined proximity. This proximity of interest may vary according to specific market research applications. For example, in some cases market research applications may be initiated where a mobile respondent has come within a mile of a location of interest, while other applications may be initiated where the mobile respondent has come within 20 feet of a location of interest.

The market research application may be received by a mobile respondent operating a mobile device before, during, or after the mobile respondent is actually at the location of interest. Accordingly, the market research application may question a respondent about their past experiences, about the current experiences, or may be couched in terms of what the respondent is soon expected to experience.

At block 402 market research data based on the market research application is transmitted. The market research data may comprise a completed survey, a partially-completed survey, a decline to participate in the survey, a request for additional data or instructions, an error message signifying an unsuccessful survey process (perhaps due to low signal strength of mobile device 103), etc.

At block 403 a refined market research application is received. The refined mobile market research application may also be received as a response to the market research data previously transmitted by the mobile respondent. For example, the refined market research application may include follow-up questions, requests for clarifying or additional data, and an indication the first market research was not fully received. The refined mobile market research application may also be received upon a determination the mobile respondent is at, e.g., a closer proximity to a location of interest. According to the previously discussed example of providing a market research application based on a respondent's shopping experience, the refined market research application may be transmitted to the mobile respondent, i.e., where a survey relating to a product, display, or layout on a specific aisle is transmitted to the mobile respondent as opposed to a more general survey relating to the respondent's shopping experience at the store. Further, the refined market research application may further be received upon a determination the mobile respondent has been in proximity to a location of interest for a determined length of time.

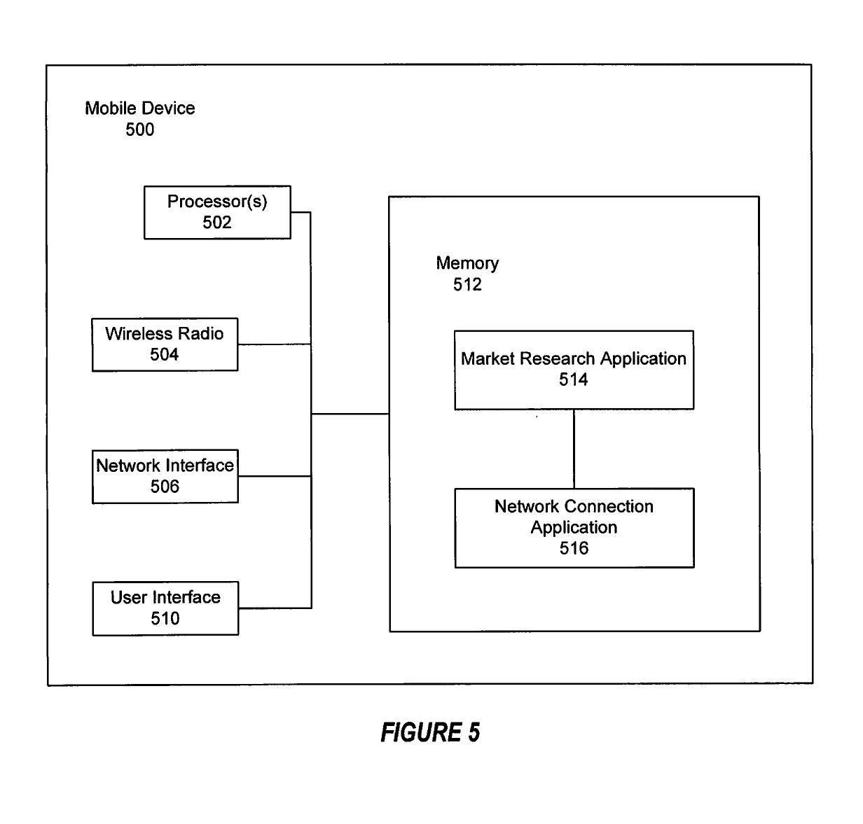

FIG. 5 illustrates a block diagram of components of an apparatus that enables mobile respondent market research according to the concepts described herein. Specifically, FIG. 5 illustrates components of a mobile device such as one or more of mobile devices 103 illustrated at FIG. 1. Each component may comprise hardware, software, firmware, program code, or other logic (for example, ASIC, FPGA, etc.), as may be operable upon or executed to provide the functions described herein. As such, mobile device 500 includes various components common to many typical smart phones, tablet computers, notebook and netbook computers, computers, and the like. Devices, such as mobile device 500 include the processing power, memory, and programming to perform complex tasks, run complex programs, and interact substantially with a user.

The functionality and operations of mobile device 500 are controlled and executed through processor(s) 502. Processor(s) 502 may include one or more core processors, central processing units (CPUs), graphical processing units (GPUs), math co-processors, and the like. Processor(s) 502 execute program logic, whether implemented through software stored in a memory 512 or in firmware in which logic is integrated directly into integrated circuit components. Mobile device 500 may communicate wirelessly through various radios, such as wireless radio 504, such as one or more of wireless wide area network (WWAN) radios and wireless local area network (WLAN) radios, such as WIFI™ radios, BLUETOOTH® radios, and the like. If a WWAN radio is included as one of the radios in wireless radio 504, communication would generally be allowed to communicate over a long range wireless communication network such as 3G, 4G, LTE, and the like. Various WLAN radios, such as WIFI™ radios, BLUETOOTH® radios, and the like, would allow communication over a shorter range. Mobile device 500 may also provide communication and network access through a wired connection with network interface 506. The wired connection may connect to the public-switched telephone network (PSTN), or other communication network, in order to connect to the Internet or other accessible communication network.

Under control of processor(s) 502, program logic stored on memory 512, including market research application 514, and other applications provide functionality of mobile device 500, including communications, Internet access, and execution of various programs for productivity, entertainment, and the like. Applications stored in memory 512 may, when executed by processor(s) 502, operate calendar programs, game programs, list programs, social media programs, web browsers, and the like. Such operating applications are displayed visually to the user via user interface 510. The user interface 510 includes various hardware and software applications that control the rendering of visual data onto the display screen of the mobile device (not shown). The user interface 510, under control of the processor(s) 502, controls and operates all forms of interfaces between the user and mobile device 500. As such, when mobile device 500 is implemented using a touch screen display, user interface 510 may read the user's input and finger motions on the touch screen and translates those movements or gestures into electronic interface navigational commands and data entry. Various aspects of user interface 510 also will receive the rendered visual data through processing, controlled by processor(s) 502, and display that visual data on the display. During input to a touch screen device, the user interface 510 may be receiving and analyzing input data from a user's finger movements and gestures on the display screen. It may also be receiving data from the processor(s) 502 in the form of processed visual or sound data to be output by display to the user, some of which may be to reflect movement of screen objects in response to the user's finger movements.

Market research application 514 may configure the processor(s) 502 to extract a received market research application, whether the market research application is launched within the application itself or launched by a respondent following a link found on a webpage, text message, or email. In operation, the processor(s) 502 may launch market research application 514 in response to the respondent selection to initiate the market research application and provide market research data in response thereto. In some of these embodiments, the processor(s) 502 may employ the user interface 510 to receive respondent input to market data and establish a connection with other systems to transmit that data. Market research application 514 may be further configured to transmit mobile device location data at predetermined intervals, which may dynamically change according to concepts described herein. Further, market research application 514 may extract behavioral data from mobile device 500 according to described concepts. Network connection application 516, which may reside in market research application 514, configures the processor(s) 502 to establish a connection for mobile device 500 to transmit market research data, location data, and behavioral data in a manner that will be readily appreciated by one skilled in the art.

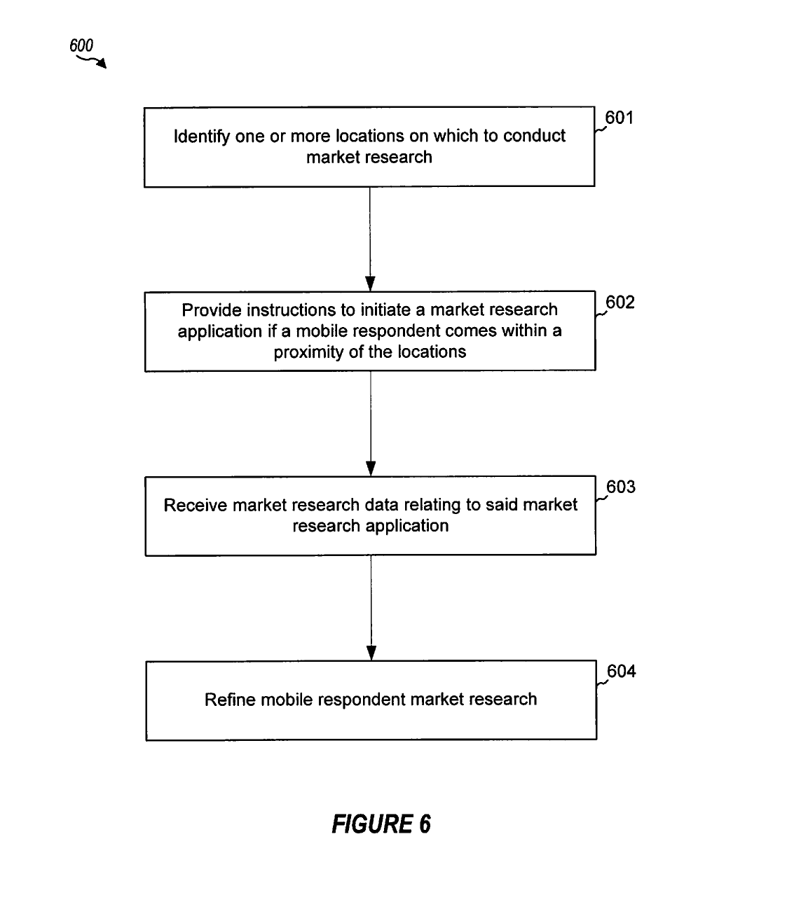

FIG. 6 illustrates functional blocks executed to perform a method of mobile respondent market research according to the concepts described herein. Specifically, FIG. 6 illustrates functional blocks executed by a client system such as market research enterprise 102 illustrated at FIG. 1. The functional blocks may be executed at the direction of one or more of hardware, software, and inputs received from a respondent.

At block 601 one or more locations on which to conduct market research is identified. A location may be identified as specific business enterprises such as particular stores, movie theaters, or car dealerships or merely in terms of raw data sufficient to describe their geographic location. Also, the location of interest may be defined in terms of “raw” data where the location of interest is defined in terms of coordinates, GPS references, latitude and longitude, and the like. In either case, the locations are identified as those which are of interest for market research.

At block 602 instructions to initiate a market research application if a mobile respondent comes within a proximity of the locations is provided. The determination may be made in different temporal respects. The determination may be made by looking back in time where one or more sets of mobile respondent location data is examined over a preceding time interval. Also, the determination may be made during or close to real-time so that a system is able to identify which mobile respondents are currently at or near a location of interest. Further, the determination may be predictive where, for example, a system predicts whether a mobile respondent will move in proximity to a location of interest at a future time.

The determination of what proximity causes transmission of the market research application may be determined by market research enterprise 102 and may vary according to different mechanisms. A determined proximity (or proximity of interest) may vary according to client system requirements, a given market research application, system limitations, and the like. Further, the proximity of interest may be provided to middleware system 101 by market research enterprise 102, or generated by middleware system 101 upon a formulation of what proximity of interests are thought to satisfy the objectives of market research enterprise 102.

With the above in mind, consider the example where market research enterprise 102 desires to conduct market research on males between the ages of 18-35 who have had a particular type of shopping experience (for example, those determined to have shopped for home improvement products). In that case, market research enterprise 102 instructs middleware system 101 to include Home Depot, Lowes, and Target, as locations of interest. Market research enterprise 102 may provide further instructions to initiate market research applications to those respondents who are male and within the specified age range to further refine returned market research data.

At block 603 market research data relating to said market research application is received. The received market research data may have been previously correlated with mobile respondent profile data and/or mobile respondent behavioral data, where the correlation was performed by middleware system 101. Otherwise, the data may be in a raw format. The received data may comprise a completed survey, a partially-completed survey, a decline to participate in the survey, a request for additional data or instructions, an error message signifying an unsuccessful survey process (perhaps due to low signal strength of mobile device 103), etc. The received data may be utilized by market research enterprise 102 in a number of ways and for a number of purposes. Where a declined survey request, an incomplete survey, or an error message is received, market research enterprise 102 may flag the mobile respondent for follow-up, initiating a subsequent market research application according to a determine time interval. Further the received data may be correlated with other data to interpret the data where, for example, complete survey data is correlated with stored mobile respondent profile data to understand how respondents of different profiles responded to the survey.

Otherwise, if not already performed, at block 604 market research data may have been previously correlated with mobile respondent profile data and/or mobile respondent behavioral data. In this case, the correlation is performed by market research enterprise 102. Correlation may be performed to provide better understanding of the market research data and/or to further refine subsequent market research applications to be transmitted to a mobile respondent. In that case, market research enterprise 102 may refine its market research applications by utilizing data collected during or in response to a first market research application and/or the previously described respondent profile data, to transmit a second market research application to the respondent.

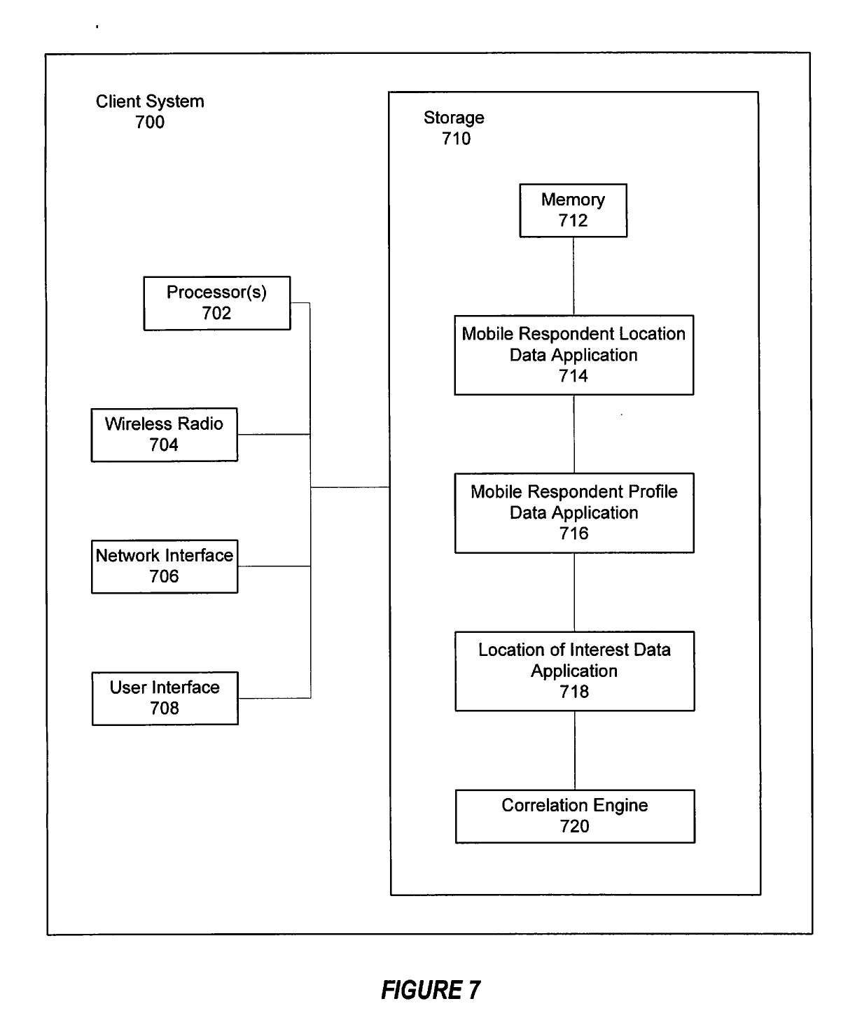

FIG. 7 illustrates a block diagram of components of an apparatus that enables mobile respondent market research according to the concepts described herein. Specifically, FIG. 7 illustrates components of a client system such as market research enterprise 102 illustrated at FIG. 1. Each component may comprise hardware, software, firmware, program code, or other logic (for example, ASIC, FPGA, etc.), as may be operable upon or executed to provide the functions described herein.

The functionality and operations of client system 700 are controlled and executed through processor(s) 702. Processor(s) 702 may include one or more core processors, central processing units (CPUs), graphical processing units (GPUs), math co-processors, and the like. Processor(s) 702 execute program logic, whether implemented through software stored in a memory 712 or in firmware in which logic is integrated directly into integrated circuit components. Client system 700 may communicate wirelessly with middleware systems or mobile devices (where, e.g., market research enterprise 102 and a middleware system are collocated) through various radios, such as wireless radio 704, such as one or more of wireless wide area network (WWAN) radios and wireless local area network (WLAN) radios. If a WWAN radio is included as one of the radios in wireless radio 704, communication would generally be allowed over a long range wireless communication network such as an LTE network. Client system 700 may also provide communication and network access through a wired connection with network interface 706. The wired connection may connect to the public-switched telephone network (PSTN), or other communication network, in order to connect to the Internet or other accessible communication network.

Client system 700 comprises storage 710, which includes memory 712, mobile respondent location data 714, mobile respondent profile data application 716, location of interest data application 718, and correlation engine 720. Under control of processor(s) 702, program logic stored on memory 712, including mobile respondent location data application 714, mobile respondent profile data application 716, location of interest data application 718, and correlation engine 720, and other applications provides functionality of client system 700, including communications, storage, computation, and filtering, analysis, and correlation of location data, profile data, and location of interest data. Such operating applications may be displayed visually to the user via user interface 708. User interface 708 includes various hardware and software applications that control the rendering of visual data onto the display screen of computers of client system 700 (not shown). User interface 708, under control of the processor(s) 702, controls and operates all forms of interfaces between the user and client system 700. As such, when client system 700 is implemented using a touch screen display, user interface 708 may read the user's input and finger motions on the touch screen and translates those movements or gestures into electronic interface navigational commands and data entry. Various embodiments of user interface 708 also will receive the rendered visual data through processing, controlled by processor(s) 702, and display that visual data on the display. During input to a touch screen device, the user interface 708 may be receiving and analyzing input data from a user's finger movements and gestures on the display screen.

Mobile respondent data application 714 may configure the processor(s) 702 to extract location data of mobile respondents for various operations described with reference to FIG. 6. This location data may be received from the middleware system in a raw format or, as described, may be correlated with other data. Mobile respondent data application 714 may be interfaced with mobile respondent profile data application 716, location of interest data application 718, and correlation engine 720 for use with market research results to correlate and/or filter the data according to specific market research goals. Mobile respondent profile data application 716 may configure the processor(s) 702 to extract the profile and/or behavioral data of mobile respondents for various operations described with reference to FIG. 6. This profile and/or behavioral data may be received from the middleware system in a raw format or, as described, may be correlated with other data. Additionally, mobile respondent profile data application 716 may extract mobile respondent profile data to retrieve demographic data, behavioral data, preferences, etc., for use with market research results to correlate and/or filter the data according to specific market research goals. Location of interest data application 718 may configure the processor(s) 702 to extract the locations of interest for various operations described with reference to FIG. 6.

Correlation engine 720 may be interfaced with mobile respondent location data application 714, mobile respondent profile data application 716, and location of interest data application 718, or used with market research results to correlate and/or filter the data according to specific market research goals.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for conducting market research, said method comprising:
identifying a location of interest;
determining whether a mobile respondent comes within a proximity of said location of interest; and
transmitting, to said mobile respondent, a market research application in response to a determination said mobile respondent came within said proximity of said location of interest.

2. The method of claim 1 further comprising:
receiving market research data from said mobile respondent based upon said market research application.

3. The method of claim 2 further comprising:
transmitting data relating to said received market research data to a client system.

4. The method of claim 1 wherein transmitting said market research application is performed while said mobile respondent is within said proximity of said location of interest.

5. The method of claim 1 wherein transmitting said market research application is performed after said mobile respondent is within said proximity of said location of interest.

6. The method of claim 1 wherein said location of interest is received from a client system.

7. The method of claim 1 wherein said location of interest is generated based upon one or more mobile respondent profiles.

8. The method of claim 7 wherein said one or more mobile respondent profiles are generated, at least in part, on data collected from said mobile respondent.

9. The method of claim 8 wherein said data is passively collected.

10. The method of claim 9 where said data is actively collected.

11. The method of claim 7 wherein data gathered from said mobile respondent is behavioral data relating to said mobile respondent.

12. The method of claim 11 wherein said behavioral data includes at least one of:
past location, text usage, phone usage, website history.

13. The method of claim 1 wherein determining whether a mobile respondent comes within a proximity of said location of interest is performed, at least in part, by comparing past locations of a mobile respondent to locations provided by a client system.

14. The method of claim 1 wherein determining whether a mobile respondent comes within a proximity of said location of interest is performed, at least in part, by constructing a virtual radius around said location of interest and determining whether said mobile respondent cross said radius.

15. The method of claim 1 wherein determining whether a mobile respondent comes within a proximity of said location of interest is performed, at least in part, by matching a plurality of market research applications from a plurality of locations of interest with a determined location of said mobile respondent.

16. The method of claim 1 wherein said market research application is a push message.

17. The method of claim 1 wherein said market research application is a text message.

18. The method of claim 1 wherein said market research application is an email.

19. The method of claim 1 further comprising:
transmitting a second market research application in response to determining said mobile respondent comes within a closer proximity to said location of interest.

20. The method of claim 1 further comprising:
transmitting a second market research application in response to determining said mobile respondent has been in said proximity of said location of interest for more than a determined time interval.

21. A system configured for market research, the system comprising:
at least one processor; and
a memory coupled to the at least one processor, wherein the at least one processor is configured to:
identify a location of interest;
determine whether a mobile respondent comes within a proximity of said location of interest; and
transmit to said mobile respondent, a market research application in response to a determination said mobile respondent came within said proximity of said location of interest.

22. The system of claim 21 wherein said processor is further configured to:
receive market research data from said mobile respondent based upon said market research application.

23. The system of claim 22 wherein said processor is further configured to:
transmit data relating to said received market research data to a client system.

24. The system of claim 21 wherein said processor is further configured to:
transmit said market research application while said mobile respondent is within said proximity of said location of interest.

25. The system of claim 21 wherein said processor is further configured to:
transmit said market research application after said mobile respondent is within said proximity of said location of interest.

26. The system of claim 21 wherein said processor is further configured to:
receive said location of interest from a client system.

27. The system of claim 21 wherein said processor is further configured to:
generate said location of interest based upon one or more mobile respondent profiles.

28. The system of claim 27 wherein said processor is further configured to:
generate said one or more mobile respondent profiles, at least in part, on data collected from said mobile respondent.

29. The system of claim 28 wherein said processor is further configured to:
passively collect said data.

30. The system of claim 29 wherein said processor is further configured to:
actively collect said data.

31. The system of claim 27 wherein said processor is further configured to:
receive behavioral data relating to said mobile respondent.

32. The system of claim 31 wherein said behavioral data includes at least one of past location, text usage, phone usage, website history.

33. The system of claim 21 wherein said processor is further configured to determine whether a mobile respondent comes within a proximity of said location of interest by comparing past locations of a mobile respondent to locations provided by a client system.

34. The system of claim 21 wherein said processor is further configured to determine whether a mobile respondent comes within a proximity of said location of by constructing a virtual radius around said location of interest and determining whether said mobile respondent crosses said radius.

35. The system of claim 21 wherein said processor is further configured to determine whether a mobile respondent comes within a proximity of said location of interest by matching a plurality of market research applications from a plurality of locations of interest with a determined location of said mobile respondent.

36. The system of claim 21 wherein said market research application is a push message.

37. The system of claim 21 wherein said market research application is a text message.

38. The system of claim 21 wherein said market research application is an email.

39. The system of claim 21 wherein said processor is further configured to:
transmit a second market research application in response to determining said mobile respondent comes within a closer proximity to said location of interest.

40. The system of claim 21 wherein said processor is further configured to:
transmit a second market research application in response to determining said mobile respondent has been in said proximity of said location of interest for more than a determined time interval.

41. A market research method, said method comprising:
receiving, at a mobile device, a market research application, said market research application selected, at least in part, in response to a determination of said mobile device's proximity to a location of interest; and
transmitting, from said mobile device, market research data based upon said market research application.

42. The method of claim 41 further comprising:
receiving, at a mobile device, a second market research application, said second market research application selected, at least in part, in response to said transmitted market research data.

43. The method of claim 42 further comprising:
wherein said second market research application is selected, at least in part, based on a determination of said mobile device's second proximity to said location of interest.

44. The method of claim 43 further comprising:
wherein said second market research application is selected, at least in part, based on a determination of a length of time said mobile device is in said proximity to said location of interest.

45. The method of claim 41 wherein receiving said market research application is performed while said mobile device is within said proximity of said location of interest.

46. The method of claim 41 wherein receiving said market research application is performed after said mobile device is within said proximity of said location of interest.

47. The method of claim 41 further comprising:
transmitting, from said mobile device, profile data relating to a respondent using said mobile device.

48. The method of claim 41 further comprising:
transmitting, from said mobile device, behavioral data relating to a respondent using said mobile device.

49. The method of claim 45 wherein said behavioral data includes at least one of: past location, text usage, phone usage, website history.

50. The method of claim 41 wherein determining whether a mobile respondent comes within a proximity of said location of interest is performed, at least in part, by comparing past locations of a mobile respondent to locations provided by a client system.

51. The method of claim 41 wherein determining whether a mobile respondent comes within a proximity of said location of interest is performed, at least in part, by constructing a virtual radius around said location of interest and determining whether said mobile respondent crosses said radius.

52. The method of claim 41 wherein determining whether a mobile respondent comes within a proximity of said location of interest is performed, at least in part, by matching a plurality of market research applications from a plurality of locations of interest with a determined location of said mobile respondent.

53. The method of claim 41 wherein said market research application is a push message.

54. The method of claim 41 wherein said market research application is a text message.

55. The method of claim 41 wherein said market research application is an email.

56. A system configured for market research, the system comprising:
at least one processor; and
a memory coupled to the at least one processor, wherein the at least one processor is configured to:
receive, at a mobile device, a market research application, said market research application selected, at least in part, in response to a determination of said mobile device's proximity to a location of interest; and
transmit, from said mobile device, market research data based upon said market research application.

57. The system of claim 56 wherein said processor is further configured to:
receive, at a mobile device, a second market research application, said second market research application selected, at least in part, in response to said transmitted market research data.

58. The system of claim 57 wherein said second market research application is selected, at least in part, based on a determination of said mobile device's second proximity to said location of interest.

59. The system of claim 57 wherein said second market research application is selected, at least in part, based on a determination of a length of time said mobile device is in said proximity to said location of interest.

60. The system of claim 56 wherein said processor is further configured to:
receive said market research application while said mobile device is within said proximity of said location of interest.

61. The system of claim 56 wherein said processor is further configured to:
receive said market research application after said mobile device is within said proximity of said location of interest.

62. The system of claim 56 wherein said processor is further configured to:
transmit from said mobile device, profile data relating to a respondent using said mobile device.

63. The system of claim 56 wherein said processor is further configured to:
transmit, from said mobile device, behavioral data relating to a respondent using said mobile device.

64. The system of claim 60 wherein said behavioral data includes at least one of: past location, text usage, phone usage, website history.

65. The system of claim 56 wherein determining whether a mobile respondent comes within a proximity of said location of interest is performed, at least in part, by comparing past locations of a mobile respondent to locations provided by a client system.

66. The system of claim 56 wherein determining whether a mobile respondent comes within a proximity of said location of interest is performed, at least in part, by constructing a virtual radius around said location of interest and determining whether said mobile respondent crosses said radius.

67. The system of claim 56 wherein determining whether a mobile respondent comes within a proximity of said location of interest is performed, at least in part, by matching a plurality of market research applications from a plurality of locations of interest with a determined location of said mobile respondent.

68. The system of claim 56 wherein said market research application is a push message.

69. The system of claim 56 wherein said market research application is an email.

70. The system of claim 56 wherein said market research application is a text message.

71. A market research method, said method comprising:
identifying one or more locations on which to conduct market research;
providing instructions to initiate a market research application upon a determination a mobile respondent comes within a proximity of said one or more locations; and
receiving market research data relating to said market research application.

72. The method of claim 71 further comprising correlating said received market research data with mobile respondent profile data.

73. The method of claim 71 further comprising correlating said received market research data with mobile respondent behavioral data.

74. The method of claim 71 wherein said received market research data has been correlated with mobile respondent profile data.

75. The method of claim 71 wherein said received market research data has been correlated with mobile respondent behavioral data.

76. The method of claim 71 wherein said one or more locations are associated with a specific business entity on which market research is to be conducted.

77. The method of claim 71 wherein said proximity is chosen according to said market research application.

78. A system configured for market research, the system comprising:
at least one processor; and
a memory coupled to the at least one processor, wherein the at least one processor is configured to:
identify one or more locations on which to conduct market research;
provide instructions to initiate a market research application upon a determination a mobile respondent comes within a proximity of said one or more locations; and
receive market research data relating to said market research application.

79. The system of claim 78 wherein said processor is further configured to:
correlate said received market research data with mobile respondent profile data.

80. The system of claim 78 wherein said processor is further configured to:
correlate said received market research data with mobile respondent behavioral data.

81. The system of claim 78 wherein said processor is further configured to:
receive market research data that has been correlated with mobile respondent profile data.

82. The system of claim 78 wherein said processor is further configured to:
receive market research data that has been correlated with mobile respondent behavioral data.

83. The system of claim 78 wherein said processor is further configured to:
select one or more locations associated with a specific business entity for market research.

84. The system of claim 78 wherein said processor is further configured to:
choose said proximity according to said market research application.
